(19) United States
(12) Patent Application Publication
(10) Pub. No.: US 2014/0026364 A1
(43) Pub. Date: Jan. 30, 2014

(54) ROTARY SHAFT FORCE-UNIFORMING STRUCTURE

(71) Applicant: An Szu HSU, New Taipei City (TW)

(72) Inventor: An Szu HSU, New Taipei City (TW)

(73) Assignee: FIRST DOME CORPORATION, New Taipei City (TW)

(21) Appl. No.: 13/558,569

(22) Filed: Jul. 26, 2012

(51) Int. Cl. E05D 11/10

(52) U.S. Cl. 16/333

(57) ABSTRACT

A rotary shaft force-uniforming structure includes a pivot pin and a pivot seat. The pivot pin has at least one pivoted section with a circular cross section. One side of the pivot seat is curled to form an elastic section defining therein a pivotal fitting space for elastically enclosing the pivoted section. A part of the circumferential wall of the pivotal fitting space is formed with a plane straight face, whereby the pivoted section of the pivot pin contacts the circumferential wall of the pivotal fitting space at three contact sections to stably assemble the pivot pin with the pivot seat. Also, the rotary shaft force-uniforming structure always provides a stable resistance against the rotation of the pivot pin. Moreover, when the pivot pin is rotated within the pivotal fitting space, the deformation (expansion or contraction) of the elastic section of the pivot seat is limited.

### BACKGROUND OF THE INVENTION

1. Field of the Invention

The present invention relates generally to a rotary shaft force-uniforming structure, and more particularly to a rotary shaft structure, which is able to keep the pivot pin in uniform contact with the pivot seat and provide a stable frictional resistance against the rotation and limit the deformation of the pivot seat so as to ensure best quality of pivotal rotation.

2. Description of the Related Art

FIG. 1 shows a conventional rotary shaft structure capable of providing suitable rotational torque. The rotary shaft structure is generally composed of a pivot pin 4 and a pivot seat 3 enclosing the pivot pin 4. At least a part of the pivot pin 4 can be mechanically processed to form a pivoted section with a circular cross section. The pivot seat is simply made of a metal board material. One side of the pivot seat is formed with a pivotal fitting space 31 for elastically enclosing the pivoted section. The circumferential wall of the pivotal fitting space applies an elastic force to the pivoted section to provide a frictional resistance against the rotation of the pivot pin 4. Accordingly, the pivot pin can be freely located in any desired angular position. However, in practice, the above structure has some shortcomings as follows:

1. The pivot seat 3 is simply made of a metal board material by bending. Under the limitation of the precision of the mold and the elastic restoring effect of the metal board material, the pivotal fitting space 31 can hardly have a circular cross section with a good roundness. After the pivot pin 4 is mechanically processed, the pivoted section of the pivot pin often has a cross section with an approximately true roundness. Therefore, the pivot pin 4 can hardly fully uniformly contact the circumferential wall of the pivotal fitting space 31. (As shown in FIG. 1, the pivot pin 4 contacts the pivot seat 3 at two contact sections a and b). Such two-section contact between the pivot pin 4 and the pivot seat 3 leads to a very unstable structure. As a result, the resistance against the rotation is non-uniform. This will cause unsmoothness of the pivotal rotation and affect the operation precision of the product.

2. Frictional force exists between the circumferential wall of the pivotal fitting space 31 of the pivot seat 3 and the pivot pin 4. In general, the pivotal fitting space 31 is expandable or Contractible with the rotation of the pivot pin 4. Therefore, when the pivot pin 4 is pivotally rotated (such as in a counterclockwise direction as shown in FIG. 2), due to the non-uniform contact between the circumferential wall of the pivotal fitting space 31 and the pivoted pin 4, the pivotal fitting space 31 is often unexpectedly instantaneously massively deformed (expanded or contracted). Also, the pivot pin 4 will contact the circumferential wall of the pivotal fitting space 31 at two different contact sections (such as contact sections c and d as shown in FIG. 2). As a result, the resistance against the pivotal rotation can hardly keep stable. This will lead to great trouble in design and development of the product.

It is therefore tried by the applicant to provide a rotary shaft force-uniforming structure to overcome the above problems existing in the conventional torque rotary shaft structure.

### SUMMARY OF THE INVENTION

It is therefore a primary object of the present invention to provide a rotary shaft force-uniforming structure, which is able to keep the pivot pin in contact with the relatively rotated pivot seat at fixed contact sections so as to provide stable resistance against the rotation and thus enhance the smoothness and precision of the operation.

It is a further object of the present invention to provide the above rotary shaft force-uniforming structure in which when the pivot pin is rotated within the pivot seat, the deformation (expansion or contraction) of the pivot seat is minimized and stabilized so as to reduce the inconvenience in development and design of the product.

To achieve the above and other objects, the rotary shaft force-uniforming structure of the present invention includes: a pivot pin having at least one pivoted section with a circular cross section; and a pivot seat having a pivotal fitting space for elastically enclosing the pivoted section. A part of the circumferential wall of the pivotal fitting space is formed with a plane straight face, whereby the pivoted section of the pivot pin contacts the circumferential wall of the pivotal fitting space at at least three contact sections including a contact section on the plane straight face.

In the above rotary shaft force-uniforming structure, at least one side of the pivot seat is curled to form an elastic section. The pivotal fitting space is defined in the curled elastic section.

In the above rotary shaft force-uniforming structure, the pivot pin has a connection section for fixedly connecting with an external pivotal rotary member and the pivot seat further has a connection section for fixedly connecting with an external relative pivotal rotary member.

In the above rotary shaft force-uniforming structure, an annular raised stop section is disposed on the pivot pin between the pivoted section and the connection section.

The present invention can be best understood through the following description and accompanying drawings, wherein:

### BRIEF DESCRIPTION OF THE DRAWINGS

FIG. 1 is a side view of a conventional rotary shaft structure capable of providing rotational torque;

FIG. 2 is a side view according to FIG. 1, showing that the pivot pin is rotated to another angular position;

FIG. 3 is a perspective exploded view of the present invention;

FIG. 4 is a perspective assembled view of the present invention;

FIG. 5 is a side view according to FIG. 4; and

FIG. 6 is a side view according to FIG. 5, showing that the pivot pin is rotated to another angular position.

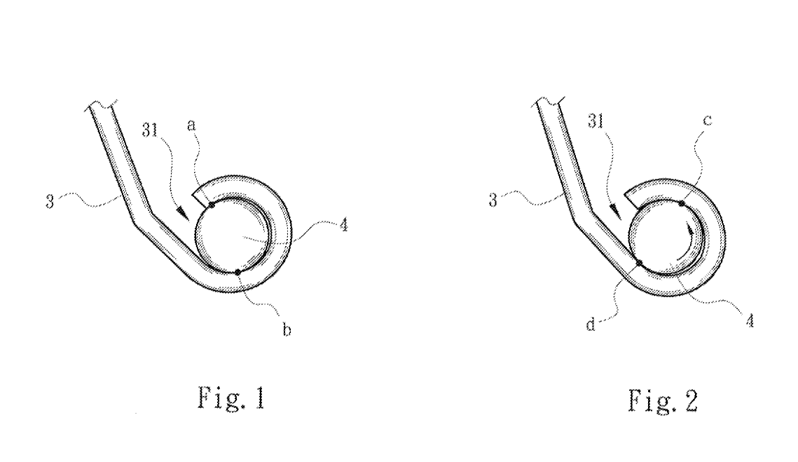

### DETAILED DESCRIPTION OF THE PREFERRED EMBODIMENTS

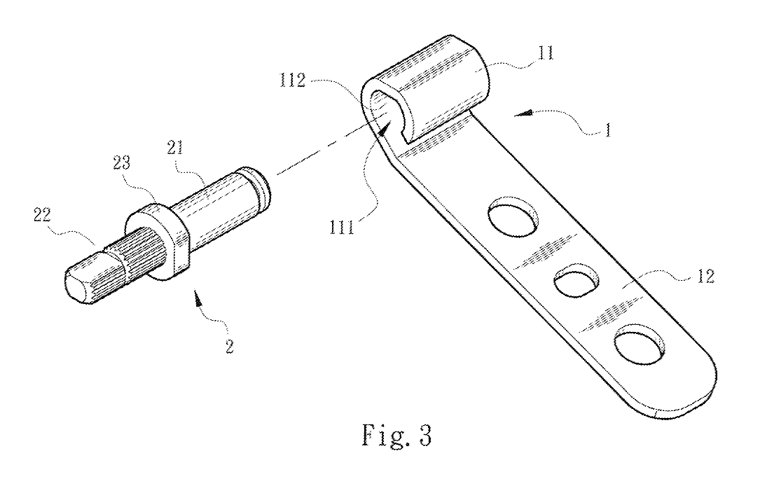

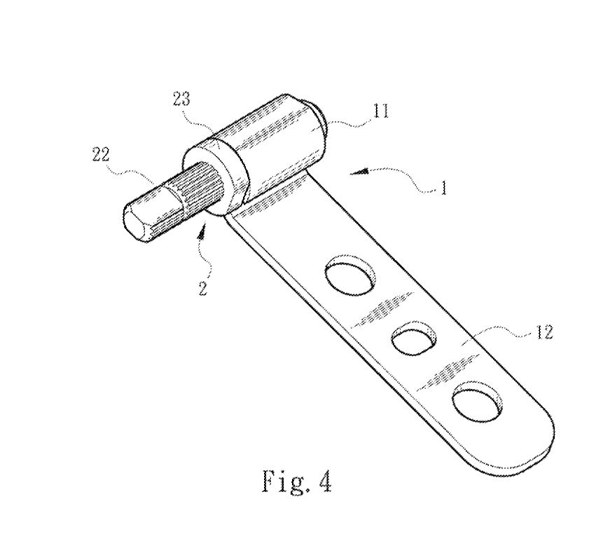

Please refer to FIGS. 3 to 5. The rotary shaft force-uniforming structure of the present invention includes a pivot seat 1 and a pivot pin 2. The pivot seat 1 is made of a metal plate. At least one side of the pivot seat 1 is curled to form an elastic section 11. The elastic section 11 defines therein a pivotal fitting space 111. A part of the circumferential wall of the pivotal fitting space 111 (preferably in the middle of the elastic section 11) is formed with a plane straight face 112. The pivot seat 1 further has a connection section 12 for fixedly connecting with an external relative pivotal rotary member (not shown). An end section of the pivot pin 2 is formed with a pivoted section 21 with a circular cross section. The pivoted section 21 can be elastically enclosed in the pivotal fitting space 111. The other end section of the pivot pin 2 is formed with a connection section 22 for fixedly connecting with an external pivotal rotary member (not shown). An annular raised stop section 23 is disposed on the pivot pin 2 between the pivoted section 21 and the connection section 22 as necessary.

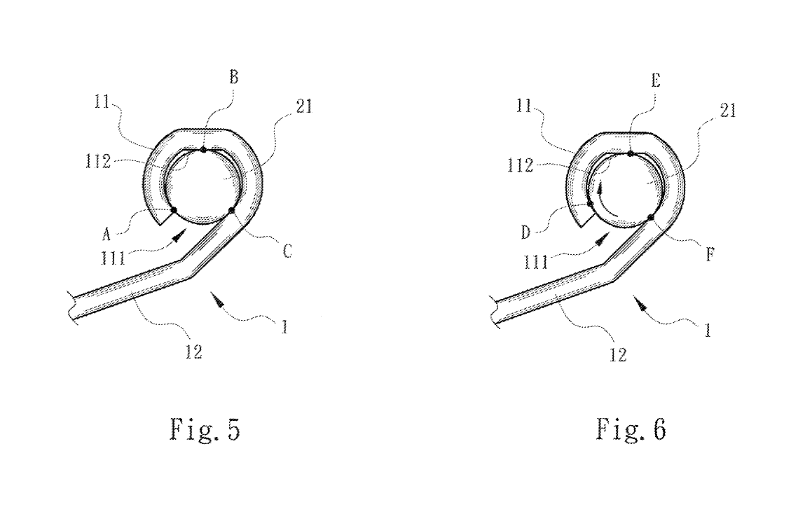

When assembled, the pivoted section 21 of the pivot pin 2 is fitted in the pivotal fitting space 111 of the pivot seat 1. The pivoted section 21 has a circular cross section. Therefore, the pivoted section 21 naturally contacts the circumferential wall of the pivotal fitting space 111 at three contact sections (contact sect ions A, B and C as shown in FIG. 5) And stably connects therewith. Under such circumstance, a stable resistance against relative rotation between the pivot seat 1 and the pivot pin 2 is provided to enhance the smoothness and precision of the operation.

Please refer to FIG. 6. In use of the present invention, in the beginning, the pivoted section 21 of the pivot pin 2 contacts the circumferential wall of the pivotal fitting space 111 of the pivot seat 1 at at least three contact sections A, B and C including the contact section B on the plane straight face 112. Accordingly, the pivot pin 2 is securely supported and a stable frictional resistance is provided for the pivot pin 2. When the pivot pin 2 is rotated clockwise as shown in FIG. 6, the elastic section 11 (the circumferential wall of the pivotal fitting space 111) is deformed along with the rotation of the pivot pin 2. At this time, the pivoted section 21 turns to contact the circumferential wall of the pivotal fitting space 111 at three contact sections D, E and F. The contact sections A, B and C or the contact sections D, E and F are all uniformly distributed and the positions thereof are only very slightly changed. Therefore, the elastic section 11 is uniformly and very slightly deformed (expanded or contracted). This can be easily considered and rectified when developing and designing the product to meet the practical requirement.

In conclusion, the rotary shaft force-uniforming structure of the present invention can keep the contact between the pivot pin and the pivot seat uniform and always provide a stable frictional resistance and deformation so as to ensure best rotational quality.

The above embodiments are only used to illustrate the present invention, not intended to limit the scope thereof. Many modifications of the above embodiments can be made without departing from the spirit of the present invention.

What is claimed is:

1. A rotary shaft force-uniforming structure comprising:
a pivot pin having at least one pivoted section with a circular cross section; and
a pivot seat having a pivotal fitting space for elastically enclosing the pivoted section, a part of a circumferential wall of the pivotal fitting space being formed with a plane straight face, whereby the pivoted section of the pivot pin contacts the circumferential wall of the pivotal fitting space at at least three contact sections including a contact section on the plane straight face.

2. The rotary shaft force-uniforming structure as claimed in claim 1, wherein at least one side of the pivot seat is curled to form an elastic section, the pivotal fitting space being defined in the curled elastic section.

3. The rotary shaft force-uniforming structure as claimed in claim 1, wherein the pivot pin has a connection section for fixedly connecting with an external pivotal rotary member and the pivot seat further has a connection section for fixedly connecting with an external relative pivotal rotary member.

4. The rotary shaft force-uniforming structure as claimed in claim 2, wherein the pivot pin has a connection section for fixedly connecting with an external pivotal rotary member and the pivot seat further has a connection section for fixedly connecting with an external relative pivotal rotary member.

5. The rotary shaft force-uniforming structure as claimed in claim 3, wherein an annular raised stop section is disposed on the pivot pin between the pivoted section and the connection section.

6. The rotary shaft force-uniforming structure as claimed in claim 4, wherein an annular raised stop section is disposed on the pivot pin between the pivoted section and the connection section.
